(19) United States
(12) Patent Application Publication
(10) Pub. No.: US 2016/0032039 A1
(43) Pub. Date: Feb. 4, 2016

(54) METHOD FOR PRODUCING CROSSLINKED FLUOROELASTOMER

(71) Applicant: NICHIAS CORPORATION, Tokyo (JP)

(72) Inventors: Tomoya Shimizu, Tokyo (JP); Ayumi Maezawa, Tokyo (JP); Yuriko Sekimoto, Tokyo (JP); Naoya Kuzawa, Tokyo (JP)

(73) Assignee: Nichias Corporation, Tokyo (JP)

(21) Appl. No.: 14/783,297

(22) PCT Filed: Mar. 27, 2014
(86) PCT No.: PCT/JP2014/001786

§ 371 Date: Oct. 8, 2015

(30) Foreign Application Priority Data
Apr. 9, 2013 (JP) 2013-081478

(51) Int. Cl. C08F 259/08

(52) U.S. Cl. CPC C08F 259/08

(57) ABSTRACT

A method for producing a cross-linked fluoroelastomer including cross-linking a fluoroelastomer with a cross-linking agent in an inert gas atmosphere in the presence of an initiator.

### TECHNICAL FIELD

The invention relates to a method for producing a cross-linked fluoroelastomer and a cross-linked fluoroelastomer obtained by this method.

### BACKGROUND ART

Water vapor is used in various applications such as bacteria removal, washing or the like in addition to power generation in various industries including plants, machinery, foodstuff and health care. A sealing material such as a rubber O-ring is used in a pipe or an apparatus through which the water vapor flows, and serves to prevent leakage of water vapor to the outside.

In recent years, in power generation plants, in order to improve power generation efficiency, there has been a tendency of increasing the temperature of water vapor than before. With this tendency, a sealing material is required to have resistance to high-temperature water vapor. In such cases, a sealing material made of cross-linked fluoroelastomer such as fluororubber and perfluororubber that has excellent heat resistance is often used. However, while a sealing material made of the cross-linked fluoroelastomer has excellent heat resistance, it may have poor resistance to vapor, and hence, improvement is required in this respect (see Patent Document 1, for example).

### RELATED ART DOCUMENT

### Patent Document

Patent Document 1: JP-A-2006-9010

### SUMMARY OF THE INVENTION

The invention has been made in view of the above-mentioned problems, and one object thereof is to provide a cross-linked fluoroelastomer having improved vapor resistance and a production method thereof.

Further, one object of the invention is to provide a novel cross-inking agent [0006]

According to one aspect of the invention, a method for producing a cross-linked fluoroelastomer comprising cross-linking a fluoroelastomer with a cross-linking agent in an inert atmosphere in the presence of an initiator is provided.

According to another aspect of the invention, a cross-linked fluoroelastomer obtained by the above-mentioned production method and a formed product are provided.

According to another aspect of the invention, a cross-linked fluoroelastomer and a formed product exhibiting a small percentage change in swelling ratios are provided.

According to another aspect of the invention, the following cross-linking agents are provided.

CF₂═CF—(CF₂)_{X}—CF═CF₂

CF₂═CH—(CF₂)_{X}—CH═CF₂

(in the formulas, x is 2 to 24)

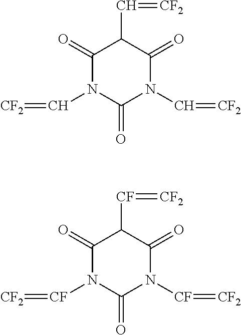

According to the invention, it is possible to provide a cross-linked fluoroelastomer having improved vapor resistance and a production method thereof.

According to the invention, it is possible to provide a novel cross-linking agent.

### MODE FOR CARRYING OUT THE INVENTION

One embodiment of the invention will be explained below. The invention is not restricted to this embodiment.

The method for producing a fluoroelastomer according to one embodiment of the invention comprises cross-linking a fluoroelastomer with a cross-linking agent in an inert gas atmosphere in the presence of an initiator. By cross-linking in an inert gas atmosphere, vapor resistance is significantly improved.

As the inert gas, nitrogen, helium, argon or the like can be used. Among them, nitrogen is preferable. In the inert gas atmosphere, the oxygen concentration is preferably 10 ppm or less, more preferably 5 ppm or less.

The fluoroelastomer may be a perfluoroelastomer, or may be a partially-fluorinated elastomer.

For example, the following monomer-derived repeating units can be exemplified. The fluoroelastomer may contain one or two or more monomer-derived repeating units.

CF₂═CH₂ (vinylidene fluoride),

CF₂═CF₂ (tetrafloroethylene),

CF₂═CFCF₃ (hexafluoropropylene),

CH₂═CH₂,

CH₂═CHCH₃

The fluoroelastomer used in the invention preferably comprises, as a part to be attacked by radicals at the time of cross-linking (curing), iodine and/or bromine, more preferably iodine. A perfluoroelastomer that can be cured by a peroxidizing method is described in Patent Document 1, or the like, for example.

In general, a perfluoroelastomer comprises iodine in an amount of 0.001 wt % to 5 wt %, preferably 0.01 to 2.5 wt %, relative to the total weight of the polymer. Iodine atoms can be present along the chain and/or at the terminal.

It is preferred that a perfluoroelastomer be produced from a copolymer such as perfluorinated olefin having an ethylenic unsaturated bond, preferably at its terminal.

As a comonomer, the following can be exemplified.

CF₂═CFOR_{2f} (per)fluoroalkylvinylether (PAVE)

(In the formula, R_{2f} is a (per)fluoroalkyl having 1 to 6 carbon atoms, e.g. trifluoromethyl or pentafluoropropyl)

CF₂═CFOXₒ (per)fluorooxyalkylvinylether

(in the formula, X₀ is a (per)fluorooxyalkyl having 1 to 12 carbon atoms and comprising one or more ether groups, e.g. perfluoro-2-propoxypropyl)

CFX₂═CX₂OCF₂OR″_{f} (I-B)

(in the formula, R″_{f} is a linear or branched (per)fluoroalkyl having 2 to 6 carbon atoms, a cyclic (per)fluoroalkyl having 5 or 6 carbon atoms or a linear or branched (per)fluorooxyalkyl having 2 to 6 carbon atoms that include 1 to 3 oxygen atoms, and X₂ is F or H)

The (per)fluorovinylether represented by the formula (I-B) is preferably represented by the following formula:

CFX₂═CX₂OCF₂OCF₂CF₂Y (II-B)

(in the formula, Y=F or OCF₃; and X₂ is as defined above)

The perfluorovinylether represented by the following formula is more preferable.

CF₂═CFOCF₂OCF₂CF₃ (MOVE1)

CF₂═CFOCF₂OCF₂CF₂OCF₃ (MOVE2)

As the preferable monomer composition, the following can be exemplified.

Tetrafluoroethylene (TFE): 50 to 85 mol %, PAVE: 15 to 50 mol %,

TFE: 50 to 85 mol %, MOVE: 15 to 50 mol %

The perfluoroelastomer may contain a vinylidene fluoride-derived unit, a fluoroolefin having 3 to 8 carbon atoms and may contain chlorine and/or bromine, or a non-fluorinated olefin having 3 to 8 carbon atoms.

As the cross-linking agent, a cross-linking agent represented by the following formula can be used.

Z—((O)ₙ—(CH₂)ₘ—C(R₃₀)═CR₂₀R₁₀)ₜ

In the formula, R₁₀, R₂₀ and R₃₀ may be the same or different and are hydrogen, an alkyl group having 1 to 6 carbon atoms or fluorine; Z is a divalent or trivalent linking group; m is independently 0 or 1; n is independently 0 or 1; and t is 2 or 3. The plural R₁₀s may be the same as or different from each other, the plural R₂₀s may be the same as or different from each other and the plural R₃₀s may be the same as or different from each other.

When Z is a divalent linking group (that is, t is 2), the cross-linking agent may preferably be a cross-linking agent represented by the following structural formula:

R₁R₂C═C(R₃)—(CH₂)ₘ—(O)ₙ—(Z—(O)ₙ—(CH₂)ₘ—C(R₄)═CR₅R₆

In the formula, R₁, R₂, R₃, R₄, R₅ and R₆ may be the same or different and are hydrogen, an alkyl group having 1 to 6 carbon atoms or fluorine; Z is a divalent linkage group; m is independently 0 or 1; and n is independently 0 or 1.

The following cross-linking agents can be exemplified.

R₁R₂C═C(R₃)—(O)ₙ—Z—(O)ₙ—C(R₄)—CR₅R₆

R₁R₂C═C(R₃)—(CH₂)ₘ—Z—(CH₂)ₘ—C(R₄)═CR₅R₆

R₁R₂C═C(R₃)—Z—C(R₄)═CR₅R₆

(in the formula, R₁, R₂, R₃, R₄, R₅ and R₆, Z, m and n are as defined above)

R₁, R₂, R₃, R₄, R₅ and R₆ are preferably hydrogen or fluorine.

Z is preferably a linear or branched alkylene having 1 to 18 carbon atoms or cycloalkylene and may optionally contain an oxygen atom. A part or all of them may be fluorinated. For example, Z is a (per)fluoropolyoxyalkylene group.

Z is more preferably a perfluoroalkylene group having 4 to 12 carbon atoms, with 4 to 8 carbon atoms being further preferable.

When Z is a (per)fluoropolyoxyalkylene group, it may contain one or more groups selected from the following:

—CF₂CF₂O—, —CF₂CF(CF₃)O—, —CFX₁O— (in the formula, X₁=F or CF₃),

### —CF₂CF₂CF₂O—, —CF₂CH₂CH₂O—, —C₃F₆O—

Z is preferably a group represented by the following formula:

-(Q)ₚ-CF₂O—(CF₂CF₂O)ₘCF₂O)ₙ—CF₂-(Q)ₚ- (II)

(in the formula, Q is alkylene or oxyalkylene group having 1 to 10 carbon atoms, p is 0 or 1, and m and n is independently a number that allows a m/n ratio to be 0.2 to 5)

Preferably, Q is selected from the following.

—CH₂OCH₂—, —CH₂O(CH₂CH₂O)₈CH₂— (in the formula, s=1 to 3)

When t is 3, Z is preferably a trivalent residue corresponding to triazine-2,4,6-(1H,3H,5H)-trion.

As specific cross-linking agents, the following can be exemplified.

CH₂═CH—(CF₂)_{X}—CH═CH₂

CH₂═CH—CH₂—(CF₂)_{X}—CH₂—CH═CH₂

CF₂═CH—(CF₂)_{X}—CH═CF₂

CF₂═CH—CH₂—(CF₂)_{X}—CH═CF₂

CF₂═CH—O—(CF₂)_{X}—O—CH═CF₂

CF₂═CF—O—(CF₂)_{X}—O—CF═CF₂

CF₂CF—(CF₂)_{X}—CF═CF₂

(in the formulas, x is 2 to 24)

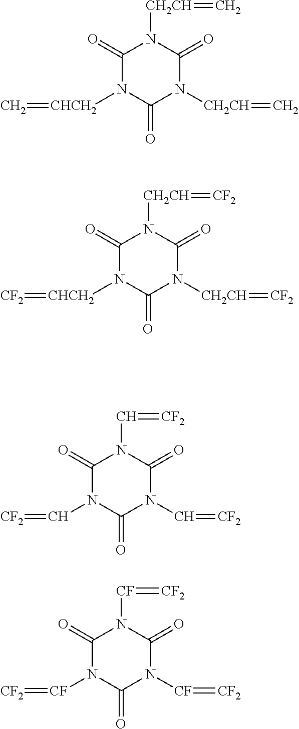

The cross-linking agent is added in an amount of preferably 0.5 to 15 mmol, more preferably 1 to 8 mmol, and further preferably 1.5 to 5 mmol relative to 100 g of the fluoroelastomer. A larger amount added tends to lead to more improved vapor resistance and heat resistance. However, if the amount of the cross-linking agent is too large, the cross-linked fluoroelastomer may tend to be hard.

As the initiator, one that is normally used can be used. For example, a peroxide, an azo compound or the like can be exemplified.

The initiator is added in an amount of preferably 0.3 to 15 mmol, more preferably 1 to 10 mmol, and further preferably 1.5 to 8 mmol relative to 100 g of the fluoroelastomer. If a large amount of the initiator is added, vapor resistance and heat resistance may likely improve. However, if the amount is too large, scorching or bubbling may occur.

A filler may be added to the above-mentioned fluoroelastomer composition in order to improve the mechanical strength. As long as the advantageous effects of the invention are not impaired, a filler that is commonly known as a filler for the elastomer can be used. For example, carbon black, silica, barium sulfide, titanium dioxide, semi-crystalline fluoropolymer and perfluoropolymer can be given.

According to need, a thickening agent, a pigment, a coupling agent, an anti-oxidant, a stabilizer or the like can be incorporated in an appropriate amount.

As for the cross-linking conditions, it is preferable to heat at 100 to 250° C. for 10 minutes to 5 hours. Normally, as the primary cross-linking, raw materials are put in a mold and the raw materials are then subjected to cross-linking while being subjected to press forming. The primary cross-linking is conducted by heating at 150 to 200° C for 5 to 60 minutes. Thereafter, the raw materials are removed from the mold, and subjected to secondary cross-linking in an inert gas atmosphere. The secondary cross-linking is conducted by heating at 150 to 300° C. for 1 to 100 hours, for example. The cross-linking can be conducted by using an electric furnace or the like. By applying thermal history through the secondary cross-linking, deformation or the like during use can be prevented.

A formed product of the cross-linked fluoroelastomer of the invention can be produced by the following method, for example.

After kneading a fluoroelastomer in which a cross-linking agent has been internally filled, an initiator and one or two or more types of carbon black (filer)) in an open roll, the resulting kneaded product is put in a mold. After subjecting the kneaded product to a heat treatment in the air, the resultant product is subjected to primary cross-linking while being subjected to press forming. Then, the resulting formed product is removed from the mold, and is then subjected to a heat treatment in a nitrogen atmosphere or in the air.

In this case, the amount of the initiator is preferably 0.1 to 4.0 phr and the amount of carbon black (filler) is preferably 0.1 to 50 phr relative to 100 parts by mass of the fluoroelastomer (when two or more carbon blacks are used, the amounts of these two or more carbon blacks may be almost equal).

The cross-linked fluoroelastomer that is obtained by the production method of the invention can be used as a sealing material, and can be used in the form of a formed product such as a gasket and a seal ring.

According to the production method of the invention, a formed product having a percentage change in swelling ratios of 100% or less before and after exposure to saturated vapor of 300° C. for 70 hours can be obtained. The swelling ratios are measured by the method described in the Examples. The percentage change in swelling ratios is preferably 90% or less, more preferably 80% or less. Further, according to the production method of the invention, a formed product having a percentage change in swelling ratios of 45% or less before and after exposure to saturated vapor of 250° C. for 70 hours can be obtained. The swelling ratios are measured by the method described in the Examples. The change in swelling ratios is preferably 40% or less, more preferably 38% or less.

Further, a formed product having a compression permanent strain measured by the method described in the Examples of 50% or less can be obtained. The compression permanent strain is preferably 40% or less, more preferably 38% or less.

### Examples

### Production Example 1

Perfluorosebacic acid HOOC(CF₂)₈COOH (10 mmol) and sodium hydroxide NaOH (20 mmol) were reacted in water, whereby a sodium salt of perfluorosebacic acid NaOOC(CF₂)₈COONa was obtained. NaOOC(CF₂)₈COONa was re-crystallized from methanol, and the resulting crystals were dried under reduced pressure at 100° C. for 12 hours. Then, an appropriate amount of benzene was added. By means of a Dean-stark apparatus, the resultant was stirred at 100° C. for 24 hours. Then, benzene was removed under reduced pressure, and vacuum-dried at room temperature for 24 hours. Thereafter, NaOOC(CF₂)₈COONa was decarboxylated by heating to 350° C. under reduced pressure. By using a dry ice strap, an intended CF₂═—(CF₂)₄—CF═CF₂ was obtained. The resultant was analyzed by ¹⁹F-NMR, and ¹⁹F-NMR (δ ppm): −88.2 (2F), −105.6 (2F), −119.5 (4F), −125.2 (4F) and −189.8 (2F) were observed. It was confirmed to be CF₂═CF—(CF₂)₄—CF═CF₂.

### Experimental Example 1

PFR94 (manufactured by Solvey Japan, Ltd.) (fluoroelastomer), perhexa 25B (manufactured by NOF Corporation) (initiator), fluorinated diene (1,6-divinylperfluorohexane) (CH₂═CH—(CF₂)₆—CH═CH₂) (cross-linking agent) were kneaded in an open roll. The kneaded product was put in a mold, and subjected to a heat treatment in the air at 170° C. for 15 minutes, whereby primary cross-linking was conducted while performing press forming. Subsequently, the formed product was removed from the mold, and then subjected to a heat treatment (rising temperature for 8 hours) at 290° C. for 16 hours in a nitrogen atmosphere (oxygen concentration: 5 ppm) or in the air, whereby a formed product of a cross-linked fluoroelastomer was obtained. The formed product was in the form of an O-ring (AS568-214; inner diameter 24.99 mm, thickness 3.53 mm).

The amounts of the initiator and the cross-linking agent relative to the fluoroelastomer (“mmol” relative to 100 g of the fluoroelastomer and “part by mass” (phr) relative to 100 parts by mass of the fluoroelastomer were both indicated) were changed as shown in Tables 1 and 2.

For the resulting secondary cross-linked fluoroelastomer, the following evaluation was conducted.

### (1) Swelling Ratio

The O-ring was cut in a length of about 10 mm, and the resultant was immersed in a perfluorocarbon solution (Fluorinate FC-3283, manufactured by 3M Japan) at room temperature (21 to 25° C., preferably 23° C.) for one week. Change in volume before and alter the test was obtained by calculation.

$$Swelling ratio [ \% ] = \frac{( Volume after test ) - ( Volume before test )}{( Volume before test )} \times 100$$

The results are shown in Table 1. In the table, the upper value indicates the value of the cross-linked fluoroelastomer after the secondary cross-linking in the air and the lower value indicates the value of the secondary cross-linked fluoroelastomer after the secondary cross-linking in a nitrogen atmosphere. The swelling ratio is an index for the cross-linking density. Since the value after the secondary cross-linking in a nitrogen atmosphere is smaller than the value after the secondary cross-linking in the air, it can be understood that a higher cross-linking density can be obtained when secondary cross-linking is conducted in a nitrogen atmosphere.

### (2) Compression Permanent Strain (CS)

The O-ring was compressed by 25%, and treated at 250° C. for 70 hours. Then, the O-ring was released and left stand at room temperature for 30 minutes. In accordance with the JIS standard (JIS K6262), the thickness before and after the test was measured, and the compression permanent strain was calculated according to the following formula.

$$Compression permanent strain [ \% ] = \frac{( Thickness before test ) - ( Thickness after test )}{( Thickness before test ) - ( Thickness of spacer )} \times 100$$

The results are shown in Table 2. A smaller value indicates an excellent heat resistance. In the table, the upper value indicates the value of the cross-linked fluoroelastomer after the secondary cross-linking in the air and the lower value indicates the value of the cross-linked fluoroelastomer after the secondary cross-linking in a nitrogen atmosphere.

TABLE 1

| | | | Perhexa 25B | | | |
|---|---|---|---|---|---|---|
| | Swelling ratio | | 0.7 | 1.4 | 2.1 | phr |
| | | | 2.4 | 4.8 | 7.2 | mmol |
| Fluori- | 1 | 2.8 | 818 | 219 | 185 | Secondary cross- |
| nated | | | | | | linking(Air) |
| diene | | | 175 | 204 | 166 | Secondary cross- |
| | | | | | | linking(N2) |
| | 2 | 5.6 | 536 | 195 | 181 | |
| | | | 157 | 141 | 148 | |
| | 3 | 8.5 | 820 | 173 | 175 | |
| | | | 159 | 136 | 141 | |
| | phr | mmol | | | | |

TABLE 2

| | | | Perhexa 25B | | | |
|---|---|---|---|---|---|---|
| | CS | | 0.7 | 1.4 | 2.1 | phr |
| | | | 2.4 | 4.8 | 7.2 | mmol |
| Fluori- | 1 | 2.8 | — | 84 | 33 | Secondary cross- |
| nated | | | | | | linking (Air) |
| diene | | | 31 | 32 | — | Secondary cross- |
| | | | | | | linking (N2) |
| | 2 | 5.6 | — | 54 | 40 | |
| | | | 23 | 38 | 40 | |
| | 3 | 8.5 | — | 37 | 43 | |
| | | | 25 | 36 | 46 | |
| | phr | mmol | | | | |

From Table 2, it can be understood that a cross-linked fluoroelastomer having excellent heat resistance can be obtained when cross-linking is conducted in a nitrogen atmosphere.

### Experimental Example 2

In the same manner as in Experimental Example 1, PFR94, Perhexa 25B and fluorinated diene were subjected to a heat-treatment at 170° C. for 15 minutes in the air. Subsequently, the resultant was subjected to a heat treatment at 290° C. for 16 hours (secondary cross-linking) in a nitrogen atmosphere (oxygen concentration: 5 ppm) or in the air.

The amount of the initiator and the amount of the cross-linking agent, each relative to 100 g of the fluoroelastomer, were 4.8 mmol (1.4 phr) and 4.2 mmol (1.5 phr), respectively.

In the same manner as in Experimental Example 1, for the resulting cross-linked fluoroelastomer after the secondary cross-linking, the swelling ratio and the compression permanent strain (CS) were evaluated.

Further, for the cross-linked fluoroelastomer after the secondary cross-linking, a vapor test was conducted. From the ratio in percentage change in swelling ratio (swelling ratio percentage change) before and after exposure for 70 hours to saturated water vapor of 300° C., vapor resistance was evaluated. The results are shown in Table 3.

$$Percentage change in swelling ratio [ \% ] = \frac{\begin{matrix}( Swelling ratio after vapor test ) - \\ ( Swelling ratio before vapor test )\end{matrix}}{( Swelling ratio before vapor test )} \times 100$$

TABLE 3

Secondary cross-linking atmosphere

| | Air | N2 |
|---|---|---|
| Swelling ratio [%] | 174 | 146 |
| before vapor test | | |
| CS [%] 250° C. × 70 h | 30 | 28 |
| Swelling ratio [%] | 541 | 256 |
| after vapor test | | |
| 300° C. × 70 h | | |
| Percentage change in | 210 | 76 |
| swelling ratio | | |

From Table 3, it can be understood that, by cross-linking in a nitrogen atmosphere, a cross-linked fluoroelastomer that has not only excellent heat resistance but also excellent vapor resistance can be obtained.

### Experimental Example 3

PFR94 (manufactured by Solvey Japan, Ltd.) (fluoroelastomer), perhexa 25B (manufactured by NOF Corporation) (initiator) and TAIC (manufactured by Nippon Kasei Chemical Co., Ltd.) (cross-linking agent) were kneaded in an open roll. The kneaded product was put in a mold, and subjected to a heat treatment in the air at 160° C. for 15 minutes, whereby primary cross-linking was conducted while performing press forming. Subsequently, the formed product was removed from the mold, and then subjected to a heat treatment at 230° C. for 8 hours in a nitrogen atmosphere (oxygen concentration: 5 ppm) or in the air, whereby a formed product of a cross-linked fluoroelastomer was obtained. The formed product was in the form of an O-ring (AS568-214).

The amount of the initiator and the amount of the cross-linking agent, each relative to 100 g of the fluoroelastomer, were 3.4 mmol (1 phr) and 8.0 mmol (2 phr), respectively.

For the cross-linked fluoroelastomer after the secondary cross-linking, the swelling ratio and the compression permanent strain (CS) were evaluated in the same manner as in Experimental Example 1.

Further, for the cross-linked fluoroelastomer after the secondary cross-linking, a vapor test was conducted. From the percentage change in swelling ratios (swelling percentage ratio) before exposure to saturated water vapor of 250° C. for 70 hours and after exposure to saturated water vapor of 250° C. for 70 hours, vapor resistance was evaluated.

The results are shown in Table 4.

### Experimental Example 4

An O-ring was prepared and evaluated in the same manner as in Experimental Example 3, except that G912 (manufactured by Daikin Industries, Inc.) (fluoroelastomer) was used instead of PFR94.

The results are shown in Table 4. The “-” (hyphen) in Table 4 means that measurement could not be conducted since the sample was broken after the vapor test.

TABLE 4

| | Secondary cross linking atmosphere | | | |
|---|---|---|---|---|
| | Air | N2 | Air | N2 |
| Composition | PFR94 + 25B 3.4 | | G912 + 25B 3.4 | |
| | mmol (1 phr) + TAIC | | mmol (1 phr) + TAIC | |
| | 8.0 mmol (2 phr) | | 8.0 mmol (2 phr) | |
| Swelling ratio [%] | 100 | 96 | 276 | 265 |
| before vapor test | | | | |
| CS[%] 250° C. × 70 h | 16 | 14 | 51 | 42 |
| Swelling ratio [%] | 154 | 129 | - | 308 |
| after vapor test | | | | |
| 250° C. × 70 h | | | | |
| Percentage | 54 | 34 | - | 16 |
| change [%] in | | | | |
| swelling ratio | | | | |

From Table 4, it can be understood that, by cross-linking in a nitrogen atmosphere, a cross-linked fluoroelastomer that has not only excellent heat resistance but also excellent vapor resistance can be obtained.

### Experimental Example 5

100 parts by mass of PFR95HT (manufactured by Solvey Japan, Ltd.) in which a cross-linking agent was filled, 0.75 phr of Perhexa 25B (manufactured by NOF Corporation) (initiator), 7 phr of MT Carbon N 990 (manufactured by Cancarb Ltd.) (carbon black (filler)) and 8 phr of Austin Black (manufactured by Coal Filers, Inc.) (carbon black) were kneaded in an open roll. The kneaded product was put in a mold, and subjected to a heat treatment in the air, whereby primary cross-linking was conducted while performing press molding. Subsequently, the formed product was removed from the mold, and then subjected to a heat treatment in a nitrogen atmosphere or in the air, whereby a cross-linked fluoroelastomer was obtained.

### INDUSTRIAL APPLICABILITY

The fluoroelastomer of the invention can be widely used as a sealing material for which vapor resistance is required.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The Japanese application specification claiming priority under the Paris Convention are incorporated herein by reference in its entirety.

1. A method for producing a cross-linked fluoroelastomer, which comprises cross-linking a fluoroelastomer with a cross-linking agent in an inert gas atmosphere in the presence of an initiator.

2. The method for producing a cross-linked fluoroelastomer according to claim 1, wherein the inert gas atmosphere is a nitrogen atmosphere.

3. The method for producing a cross-linked fluoroelastomer according to claim 1, wherein the fluoroelastomer is a perfluoroelastomer or a partially-fluorinated elastomer.

4. The method for producing a cross-linked fluoroelastomer according to claim 1, wherein the cross-linking agent is represented by the following structural formula:
Z—((O)ₙ—(CH₂)ₘ—C(R₃₀)═CR₂₀R₁₀)ₜ
wherein in the formula, R₁₀, R₂₀ and R₃₀ may be the same or different and are hydrogen, an alkyl group having 1 to 6 carbon atoms or fluorine; Z is a divalent or trivalent linking group; m is independently 0 or 1; n is independently 0 or 1, and t is 2 or 3; plural R₁₀s may be the same or different; plural R₂₀s may be the same or different; and plural R₃₀s may be the same or different.

5. The method for producing a cross-linked fluoroelastomer according to claim 4, wherein t is 2 and Z is a divalent linking group.

6. The method for producing a cross-linked fluoroelastomer according to claim 5, wherein Z is an alkylene group having 1 to 18 carbon atoms in which a part or all thereof is fluorinated.

7. The method for producing a cross-linked fluoroelastomer according to claim 4, wherein t is 3 and Z is a trivalent residue corresponding to triazine-2,4,6-(1H,3H,5H)-trion.

8. The method for producing a cross-linked fluoroelastomer according to claim 1, wherein the cross-linking agent is added in an amount of 0.5 to 15 mmol relative to 100 g of the fluoroelastomer.

9. The method for producing a cross-linked fluoroelastomer according to claim 1, wherein the initiator is added in an amount of 0.3 to 15 mmol relative to 100 g of the fluoroelastomer.

10. A cross-linked fluoroelastomer that is obtained by the production method according to claim 1.

11. A cross-linked fluoroelastomer wherein when first and second formings of the cross-linked fluoroelastomer are prepared; the second forming is exposed to saturated water vapor of 300° C. for 70 hours; the first forming without the exposure is immersed in a perfluorocarbon solution at 21 to 25° C. for one week and taken out to obtain a first swelling ratio; and the second forming after the exposure is immersed in a perfluorocarbon solution at 21 to 25° C. for one week and taken out to obtain a second swelling ratio:
the cross-linked fluoroelastomer comprises a percentage change from the first swelling ratio to the second swelling ratio of 100% or less.

12. The cross-linked fluoroelastomer according to claim 11, wherein the percentage change in swelling ratios is 80% or less.

13. A cross-linked fluoroelastomer wherein when first and second formings of the cross-linked fluoroelastomer are prepared; the second forming is exposed to saturated water vapor of 250° C. for 70 hours; the first forming without the exposure is immersed in a perfluorocarbon solution at 21 to 25° C. for one week and taken out to obtain a first swelling ratio; and the second forming after the exposure is immersed in a perfluorocarbon solution at 21 to 25° C. for one week and taken out to obtain a second swelling ratio:
the cross-linked fluoroelastomer comprises a percentage change from the first swelling ratio to the second swelling ratio of 45% or less.

14. The cross-linked fluoroelastomer according to claim 13, wherein the percentage change in swelling ratios is 38% or less.

15. The cross-linked fluoroelastomer according to claim 11, wherein the cross-linked fluoroelastomer is cross-linked with a cross-linking agent represented by the following structural formula:
Z—((O)ₙ—(CH₂)ₘ—C(R₃₀)═CR₂₀R₁₀)ₜ
wherein in the formula, R₁₀, R₂₀ and R₃₀ may be the same or different and are hydrogen, an alkyl group having 1 to 6 carbon atoms or fluorine; Z is a divalent or trivalent linking group; m is independently 0 or 1; n is independently 0 or 1; and t is 2 or 3; plural R₁₀s may be the same or different; plural R₂₀s may be the same or different; and plural R₃₀s may be the same or different.

16. The cross-linked fluoroelastomer according to claim 15, wherein t is 2 and Z is a divalent linking group.

17. A formed product obtained from the cross-linked fluoroelastomer according to claim 10.

18. A formed product according to claim 17 that is a sealing material.
